(19) United States
(12) Patent Application Publication
(10) Pub. No.: US 2026/0100451 A1
(43) Pub. Date: Apr. 9, 2026

(54) Dual-Pole Aluminum-Air Fuel Cell

(71) Applicant: Olurinde Ebenezer Lafe, Bentleyville, OH (US)

(72) Inventor: Olurinde Ebenezer Lafe, Bentleyville, OH (US)

(73) Assignee: Fuel Cells Global LTD, Bentleyville, OH (US)

(21) Appl. No.: 18/907,542

(22) Filed: Oct. 6, 2024

(51) Int. Cl. H01M 12/02; H01M 4/38; H01M 4/96; H01M 12/06; H01M 50/138

(52) U.S. Cl. CPC H01M 12/02; H01M 4/38; H01M 4/96; H01M 12/06; H01M 50/1385

(57) ABSTRACT

A method and apparatus for generating electricity using an electrochemical dual-pole fuel cell with a coiled aluminum wire disc as the anode, dual air-cathodes, and dual bioplastic electrolyte discs. The invention teaches the use of inexpensive materials and simplified dual-pole fuel cell construction and assembling of fuel cells into modules, and modules into electricity generators.

### REFERENCES

Bockstie, L., Trevethan, D. & Zaromb, S., 1963. Control of Al corrosion in caustic solutions. Journal of The Electrochemical Society, 110 (4), pp. 267-271.
Du Yuan, Jin Zhao, William Manalastas Jr., Sonal Kumar, Madhavi Srinivasan, 2020. Emerging rechageable aqueous aluminum ion battery: Status, challenges, and outlooks. Nano Materials Science, pp. 248-263.
Friesen, C. A. & Martinez, J. A. B., 2018. s.l. U.S. Pat. No. 10,090,520.
Friesen, C. A., McDowell, F. & Bautista, M. J. A., 2016. Aluminum-Based Metal-Air Batteries. United States of America, U.S. Pat. No. 9,236,643 B2.
Giuseppe, Antonio Elia, Kostiantyn V. Kravchyk, Maksym V. Kovalenko, Joaquin Chacon, Alex Holland, Richard G. A. Wills, 2021. An overview and prospective on Al and Al-ion battery technologies. Journal of Power Resources.
Miller, Y., Tzidon, D. & Yadgar, A., 2021. United States of America, US20210075078. Mori, R., 2020. Recent Developments for Aluminum-Air Batteries. Electrochemical Energy Reviews, Volume 3, pp. 344-369.
Niksa, M. J., Niksa, A. J. & Noscal, J. M., 1990. Primary alumimim-air battery. United States of America, U.S. Pat. No. 492,5744.
Sasaki, K., 2015. United States of America, US20150009365.
Wang, Y. et al., 2023. Solid-state Al-air battery with an ethanol gel electrolyte. Green Energy & Environment, 8 (4), pp. 1117-1127.
Zaromb, S., 1962. The use and behavior of aluminum anodes in alkaline primary batteries. Journal of The Electrochemical Society, 109 (12), pp. 1125-1130.

### FIELD OF INVENTION

The present invention generally relates to electricity generation, and more particularly to a method and apparatus for the conversion of the intrinsic chemical energy stored in aluminum into electricity using metal-air electrochemical fuel cells.

### PRIOR ART

Fuel cells using metal-air have historically served as robust building blocks for generators developed to meet practical applications. A metal-air fuel cell is fundamentally a primary battery. While the anode is a metal (e.g., aluminum, zinc, iron, magnesium, lithium, calcium, sodium, potassium, tin, and germanium), the cathode is oxygen drawn directly from ambient air. Metal-air appliances typically exhibit high energy densities because of the reduced weight of the cells.

Aluminum-air batteries were originally proposed by (Zaromb, 1962), and (Bockstie, et al., 1963). Developments in aluminum-air batteries were reviewed by (Mori, 2020) who provided background information on the advantages and disadvantages of several types of metal-air fuel cells and compared them with aluminum-air fuel cells. The strength of the high energy density of the aluminum-air fuel cell contrasts with the challenges in maintaining cathode stability and preventing performance-inhibiting water vapor ingress. While aqueous electrolytes provide excellent ionic conductivity and efficient aluminum dissolution, managing water loss and preventing dendrite formation have limited a broad adoption of aluminum-air fuel cells. (Wang, et al., 2023) tackled the issue of continuous aluminum corrosion during battery standby by using an ethanol gel electrolyte in an aluminum-air battery. Potassium hydroxide is the solute, and polyethylene oxide is the gelling agent.

Patents which taught different implementations of the aluminum-air fuel cell include:
(Niksa, et al., 1990) which describes an aqueous electrolyte aluminum-air battery with a consumable aluminum anode and an air cathode. The battery has a hydrophobic membrane that prevents the electrolyte from leaking out and allows hydrogen to escape. The battery is mechanically rechargeable by replacing the anode and/or the electrolyte.
(Miller, et al., 2021) which discloses aluminum-air battery units and stacks with frames that provide robust structural support and hermetic sealing for the anode and the cathode. The frame has a protective strap that protects the edges of the anode from corrosion and a trapezoidal shape that presses the strap against the anode. The anode can be replaced after electrolyte evacuation while maintaining the stack sealed.
(Sasaki, 2015) which proposes an aluminum-air battery and accumulator system that uses an electrolyte comprising a mixture of water and an ionic liquid. The system has a device for circulating the electrolyte between the battery and the accumulator, and a device for controlling the temperature and the pH of the electrolyte. The system can improve the performance and the lifetime of the battery.
(Friesen & Martinez, 2018) which relates to aluminum-based metal-air batteries that utilize an anode comprising an aluminum alloy and a cathode comprising a bifunctional catalyst. The batteries can have high energy density, high power density, and long cycle life. The batteries can also be recharged by electrochemical or mechanical methods.
(Friesen, et al., 2016) describes an aluminum-air cell using an organic solvent electrolyte that forms a protective layer on the aluminum anode during non-use, enabling efficient oxidation during discharge.

### BACKGROUND OF THE INVENTION

An aluminum-air fuel-cell is an electrochemical apparatus with cathode consisting of oxygen extracted from the air, an alkaline electrolyte, and aluminum as the anode and the fuel. Aluminum-air fuel cells hold immense potential as a sustainable energy solution. Aluminum is a readily available and inexpensive resource, making an aluminum-air fuel cell a cost-effective energy solution. The major challenge facing the widespread adoption of aluminum-air electrochemistry for practical electricity generation is the anodic aluminum self-corrosion. The electricity production of the fuel cell is severely inhibited by the reaction of the aluminum with water/oxygen in the electrolyte resulting in the production of hydrogen gas. The electrochemical reactions in an aluminum-air fuel cell, with an alkaline electrolyte, is described by (Mori, 2020):

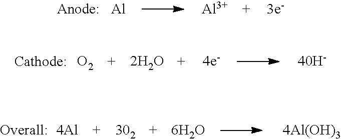

Hydroxide ions are transported from the cathode to the anode through the medium of the electrolyte. The electricity production capacity, as well as the safety and stability of the fuel cell, is strongly dependent on the nature of the electrolyte.

The typical aluminum-air fuel-cell normally converts a small fraction of the 8.1 kWh of chemical energy inherent in every kilogram of anodic aluminum into electricity. This invention teaches the use of dual electrolytes, and a coiled anodic aluminum wire disc, to produce an energy-efficient dual-cathode fuel cell. In the anodic chamber is an anolyte consisting of a bioplastic electrolyte disc derived from a compound solution of sodium hydroxide or potassium hydroxide (KOH) and an organic binder. The cathodic chamber, which is separated from the anodic chamber by a low-cost membrane separator, uses vinegar as catholyte. The use of the bioplastic anolyte significantly reduces self-corrosion, limits parasitic gas production, and improves the performance of the aluminum-air dual-pole fuel cell. Optimizing energy production per unit weight of anodic aluminum results in efficient ultra-low-cost electricity generators built using the aluminum-air fuel dual-pole-cell taught in this invention.

### SUMMARY OF THE INVENTION

According to the present invention there is provided a method of generation of electricity using a electrochemical fuel cell comprising dual air-cathodes, dual electrolytes, dual membrane separators, a coiled disc of aluminum wire anode, a bioplastic anolyte made from a compound solution of sodium hydroxide (NAOH) or potassium hydroxide (KOH), and a binder derived from Manihot esculenta (known as Cassava), vinegar-based catholyte, and exterior plastic enclosure.

An advantage of the present invention is the provision of a method and apparatus for converting the intrinsic chemical energy of aluminum into electricity.

Another advantage of the present invention is the provision of a method and apparatus for electricity generation which provides maximal conversion of the chemical energy in aluminum into electricity.

Still another advantage of the present invention is the provision of a method and apparatus for electricity generation utilizing a bioplastic electrolyte which enhances the electrochemical reactions by suppressing anodic corrosion and the evolution of hydrogen.

Still another advantage of the present invention is the provision of a method and apparatus for electricity generation which utilizes a disc of coiled aluminum wire as the solid fuel.

Still another advantage of the present invention is the provision of a method and apparatus for electricity generation which utilizes a carbonized absorbent fabric as the air-cathode medium.

Still another advantage of the present invention is the provision of a method and apparatus for electricity generation which utilizes a super absorbent fabric as the anolyte medium.

Still another advantage of the present invention is the provision of a method and apparatus for electricity generation which utilizes a low-cost polyethylene membrane separator.

Still another advantage of the present invention is the provision of a method and apparatus for electricity generation which utilizes a bioplastic anolyte soaked in a super absorbent fiber.

Still other advantages of the invention will become apparent to those skilled in the art upon reading and understanding the following detailed description, accompanying drawings and appended claims.

### BRIEF DESCRIPTION OF DRAWINGS

The invention may take physical form in certain parts and arrangements of parts, a preferred embodiment and method of which will be described in detail in this specification and illustrated in the accompanying drawings which form a part hereof, and wherein:

FIG. 1 is an illustration of the isometric view of the Dual-Pole Fuel Cell;

FIG. 2 is an illustration of the vertical cross-section of the Dual-Pole Fuel Cell;

FIG. 3 is an illustration of coiled anodic aluminum wire disc of the Dual-Pole Fuel Cell;

FIG. 4 is an illustration of the steps involved in the construction of the Dual-Pole Fuel Cell.

FIG. 5 is an illustration of stacking Dual-Pole Fuel Cells to form a Cylindrical Module.

FIG. 6 is an illustration of the isometric view of Cylindrical Modules arranged to form the Electricity Generator.

### DETAILED DESCRIPTION OF THE INVENTION

It should be appreciated that while a preferred embodiment of the present invention will be described with reference to aluminum-air fuel cell, other metal-air electrochemical cells are also suitable for use in connection with the present invention, such as zinc-air, iron-air, magnesium-air, lithium-air, calcium-air, sodium-air, potassium-air, tin-air, and germanium-air fuel cells.

In accordance with a preferred embodiment, the present invention teaches the generation of electricity using an electrochemical dual-pole fuel cell comprising: a) dual air-cathodes; b) dual electrolytes; c) dual membrane separators; d) an anode consisting of a coiled disc of aluminum wire; e) a bioplastic anolyte made from a compound solution of sodium hydroxide (NAOH) or potassium hydroxide (KOH), and a binder derived from Manihot esculenta (known as Cassava); f) vinegar-based catholyte; and g) exterior plastic enclosure.

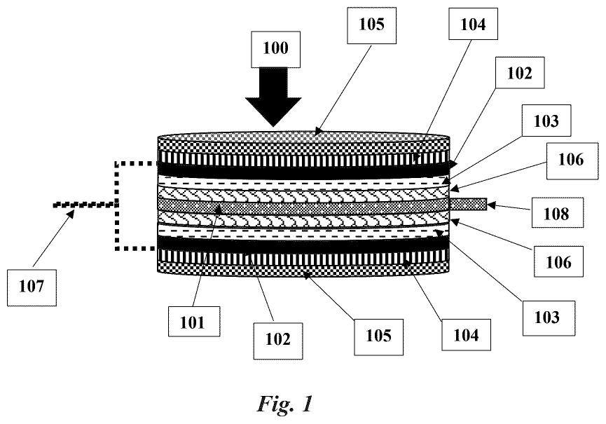

Referring now to the drawings wherein the showings are for the purposes of illustrating a preferred embodiment of the invention only and not for purposes of limiting same, FIG. 1 is an illustration of the isometric view of dual-pole fuel cell 100. At the middle of the dual-pole fuel cell is aluminum anode 101 (the fuel for the electricity generation) sandwiched by layers of bioplastic electrolyte media 106, air-cathodes 102, current collectors 104, and plastic cover discs 105. Positive terminals 107 are attached to current collectors 104.

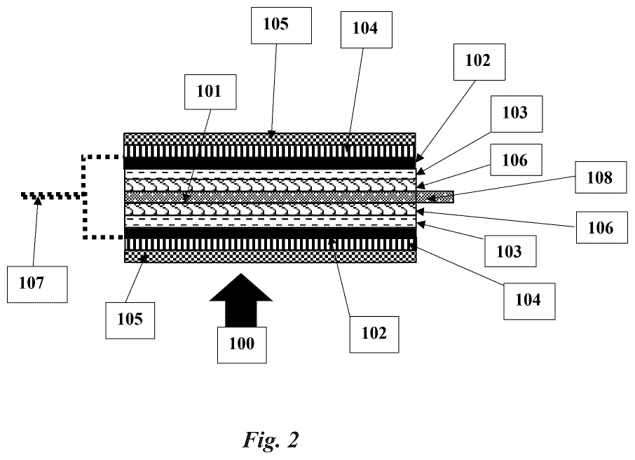

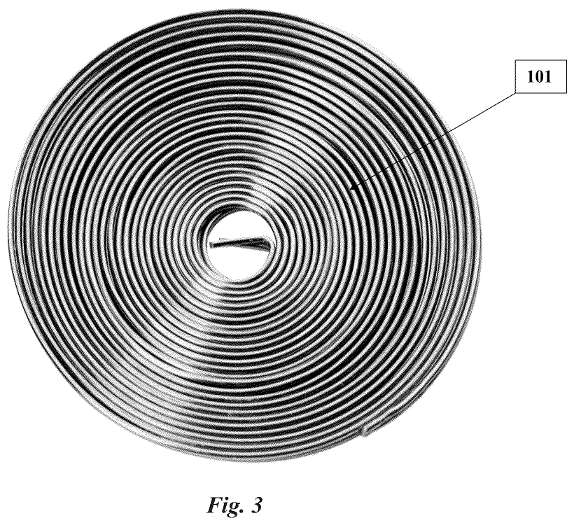

Referring now to FIG. 2 and FIG. 3:
1. Aluminum Anode 101. According to the preferred embodiment of this patent, anode 101 is pure aluminum or an alloy of aluminum in the form of a circular disc formed by a coiled wire of diameter not exceeding 3 mm (Gauge 9).
2. Air-Cathode 102. According to the preferred embodiment of this patent, air-cathode 102 is a filter or absorbent cellulosic material (such as paper towel, cotton sheet, or bamboo fiber sheet) carbonized by soaking in carbon ink made from a mixture of activated carbon powder, manganese dioxide, and vinegar.
3. Membrane Separator 103. The preferred membrane separator 103, according to this invention, is a polyethylene sheet.
4. Current Collector 104. According to the preferred embodiment of this patent, current collector 104 consists of a perforated conductive copper sheet, copper foil, or mesh of copper into a circular shape.
5. Cover Disc 105. According to the preferred embodiment of this patent, cover disc 105 is made from polypropylene plastic.
6. Bioplastic Electrolyte Media 106. According to this invention, the anolyte is formulated by mixing x parts by volume of powdery NAOH or KOH with y parts by volume of Manihot esculenta (known as Cassava), with z parts by volume of H₂O. Bioplastic Anolyte Media 106 are formed by soaking super absorbent cellulosic rounds in the anolyte.
7. Positive Terminal 107: According to the preferred embodiment of this patent, positive terminal 109, is a thin nickel strip (thickness 0.15 mm, width 8 mm) attached to current collector 104.
8. Negative Terminal 108: According to the preferred embodiment of this patent, negative terminal 108, is the protruding end of coiled aluminum wire anode 101.

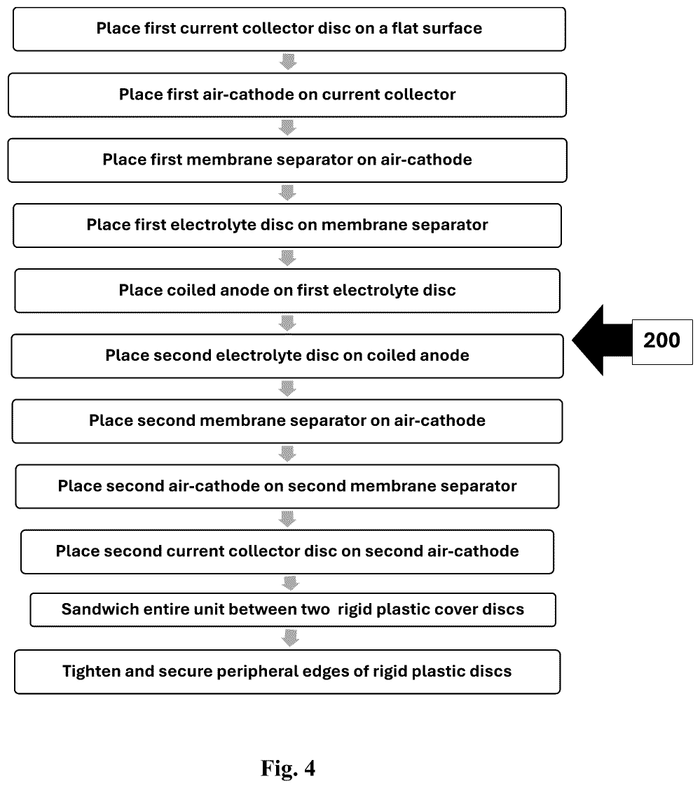

Referring now to FIG. 4, the steps 200 involved in the construction of Dual-Pole Fuel Cell 100 are:
1. Place first current collector disc 104 on a flat surface.
2. Place first air-cathode 102 on current collector 104.
3. Place first membrane separator 103 on air-cathode 102.
4. Place first electrolyte medium 106 on membrane separator 103.
5. Place coiled aluminum anode 101 on first electrolyte medium 102.
6. Place second electrolyte medium 106 on coiled aluminum anode 101.
7. Place second membrane separator 103 on second electrolyte medium 102.
8. Place second air-cathode 102 on second electrolyte medium 106.
9. Place second current collector disc 104 on second air-cathode 103.
10. Sandwich entire unit between rigid plastic cover discs 105.
11. Tighten and secure peripheral edges of cover discs 105.

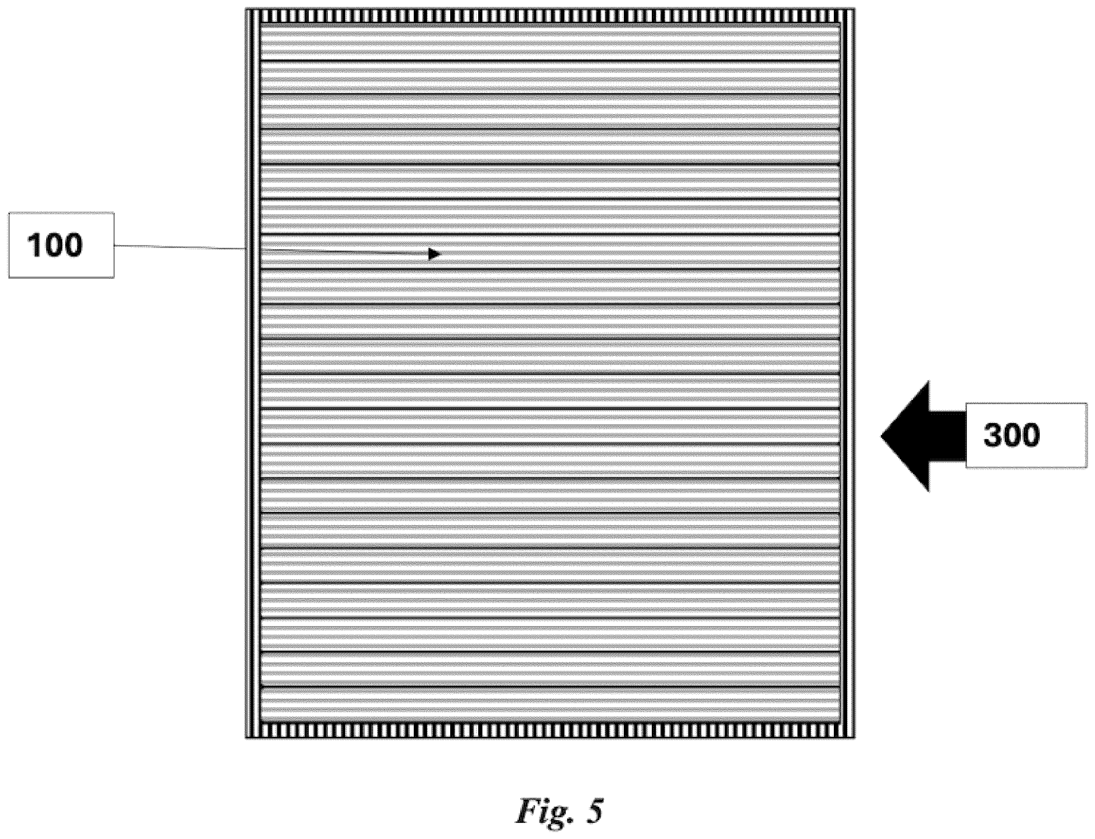

Referring now to FIG. 5:
1. Dual-Pole Fuel Cells 100 are stacked to form a Cylindrical Module 300.
2. Dual-Pole Fuel Cells 100 are connected in series or parallel to achieve specific power and energy capacities for Cylindrical Module 300.

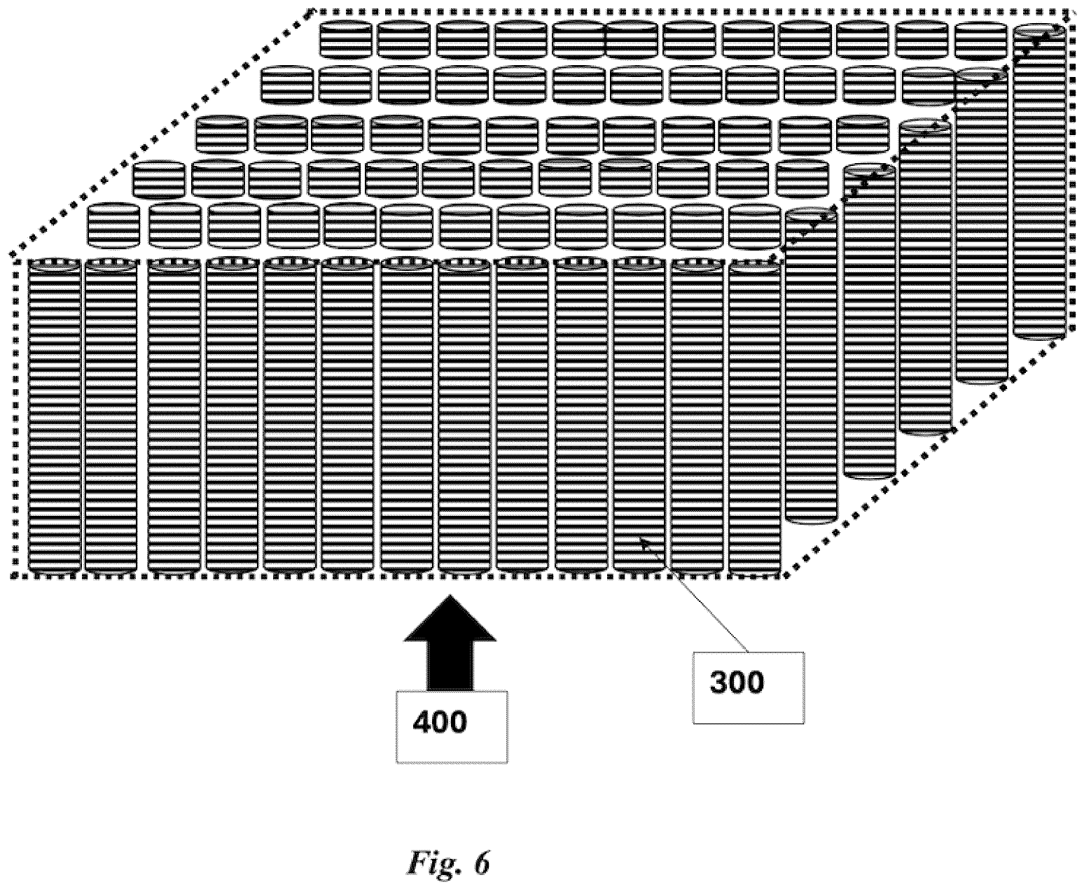

Referring now to FIG. 6:
1. Cylindrical Modules 300 are arranged in a rectangular formation to obtain Prismatic Electricity Generator 400.
2. Cylindrical Modules 300 are connected in series or parallel to achieve specific power and energy capacities for Electricity Generator 400.

### Example

To establish the characteristics of the dual-pole fuel cell, according to the invention disclosed herein, a discharge test was conducted on a dual-pole fuel cell of distinct size configuration. In the following example:
Diameter of Dual-Pole Fuel Cell: 100 mm
Thickness of Dual-Pole Fuel Cell: 12 mm
Anode: 75 mm diameter coiled Gauge 12 aluminum wire
Electrolyte Medium: 2×100 mm diameter×2 mm thick absorbent cotton pre-soaked in the bioplastic electrolyte
Anolyte: Mixture of 250 ml of sodium hydroxide, 250 ml of Manihot esculenta (Cassava) starch, and 500 ml of H₂O
Catholyte: Vinegar with 5% acidity
Air-cathode is absorbent cotton soaked in carbon ink. The carbon ink is made from a mixture of activated carbon powder and manganese dioxide in a 2:1 (by weight) ratio.
Current Collector: 2×100 mm diameter composite copper mesh and conductive copper foil
Positive Terminal: Single nickel strip attached to both current collectors
Negative Terminal: Outer end of anodic aluminum coil
Open Circuit Voltage: 1.7V
Discharge Current: 100 mA
Test duration: 12,838 minutes
Current Capacity: 21,398 mAh
Energy Produced: 16,471 mWh
Average Operating Voltage: 0.8V

The present invention has been described with reference to a preferred embodiment. Obviously, modifications and alterations will occur to others upon a reading and understanding of this specification. It is intended that all such modifications and alterations be included as far as they come within the scope of the appended claims or the equivalents thereof.

1. A method of generation of electricity using an electrochemical dual-pole fuel cell comprising dual air-cathodes, dual electrolytes, dual membrane separators, an anode consisting of a coiled disc of aluminum wire; a bioplastic anolyte, and a catholyte.

2. A method according to claim 1, wherein the anolyte is a compound solution of sodium hydroxide (NAOH) or potassium hydroxide (KOH), and a binder derived from Manihot esculenta (known as Cassava).

3. A method according to claim 1, wherein the air-cathode is a carbonized absorbent fabric material.

4. A method according to claim 1, wherein the membrane separator is a polyethylene sheet.

5. A method according to claim 1, wherein the anode is a coiled disc of aluminum wire.

6. A method according to claim 2, wherein the bioplastic anolyte is soaked in super absorbent fabric material.

7. An apparatus according to claim 1, wherein the fuel cells are stacked to form a Cylindrical Module.

8. An apparatus according to claim 7, wherein the Cylindrical Modules are arranged in rectangular grid formation and connected to form an Electricity Generator.
